(19) United States
(12) Patent Application Publication
(10) Pub. No.: US 2007/0274236 A1
(43) Pub. Date: Nov. 29, 2007

(54) Gateway apparatus and renegotiation method

(75) Inventor: Ryo Araki, Fuchu-shi (JP)

Correspondence Address: PILLSBURY WINTHROP SHAW PITTMAN, LLP;Eric S. Cherry - Docketing Supervisor, P.O. BOX 10500, MCLEAN, VA, 22102, US

(73) Assignee: KABUSHIKI KAISHA TOSHIBA, Tokyo (JP)

(21) Appl. No.: 11/802,484

(22) Filed: May 23, 2007

(30) Foreign Application Priority Data
May 24, 2006 (JP) 2006-144494

(51) Int. Cl. H04L 12/16; H04L 12/56

(52) U.S. Cl. 370/260; 370/389; 370/401

(57) ABSTRACT

According to one embodiment, a gateway apparatus includes a memory which stores information showing a plurality of codecs notified from an end point to be an originating call side in a communication connection through peer-to-peer among the first, the second and the third end points prior to the conference connection, a determiner which determines whether or not any codec matching between the first end point and the third end point exists based on information showing the plurality of codecs stored in the memory when receiving a request for dropping out from the conference connection from the second end point, and a controller which executes communication connection processing between the first end point and the third end point based on a determination result from the determiner.

### CROSS-REFERENCE TO RELATED APPLICATIONS

This application is based upon and claims the benefit of priority from the Japanese Patent Application No. 2006-144494, filed May 24, 2006, the entire contents of which are incorporated herein by reference.

### BACKGROUND

1. Field

One embodiment of the present invention relates to a system, such as an Internet protocol (IP) telephone system, which performs voice communications among terminals via an IP network, and more specifically, relates to a gateway apparatus and a renegotiation method capable of making a conference connection among terminals especially connected to the IP network.

2. Description of the Related Art

In recent years, an IP telephone system, which interactively transmits and receives images and voices as packet data in real time via an IP network, has started to prevail.

The IP telephone system connects the IP network to a line switching network, such as an analog telephone line, etc., through a gateway apparatus as well as it connects voice over Internet protocol (VoIP) terminals to the IP network. The IP telephone system may make voice communications among the VoIP terminals and non-VoIP terminals on the line switching network through performing signal conversion, etc., by a media gateway resource at the gateway apparatus.

When making the voice communications among the VoIP terminals, the IP telephone system performs the voice communications through a peer-to-peer connection unnecessary conversion processing by the gateway apparatus. Here, the peer-to-peer connection between mutual VoIP terminals needs to transmit and receive voice packets by using shared voice media codec (for example, G.711, G.722, G.729A, etc.) to and from each VoIP terminal. Therefore, in general, each VoIP terminal supports a plurality of voice media codecs.

In a session Initiation protocol (SIP), etc., that is a representative protocol of a VoIP, when carrying out the peer-to-peer connection between two terminals, an originating call terminal notifies all voice media codecs possible to support by the terminal itself to an incoming call terminal. The incoming call terminal selects one codec possible to support by the terminal itself among voice media codecs presented from the originating call terminal to return a reply that it accepts the connection using the voice media codec to the originating call terminal (e.g., Jpn. Pat. Appln. KOKAI Publication No. 2004-40653).

Meanwhile, some of the foregoing IP telephone systems provide services in which a specific VoIP terminal (organizer) calls speakers of other VoIP terminals to make conference speeches among three or more persons.

However, in the conference connection method in the foregoing IP telephone system, if the organizer drops out during the conference connection, the connections of each VoIP terminal are disconnected sometimes. This is because a gateway device try to connect the remaining VoIP terminals by peer-t-peer as the organizer drops out from the conference connection; however it cannot connect the remaining VoIP terminals by peer-to-peer without any shared voice media codec among them.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram depicting a connection configuration among VoIP terminals and a gateway apparatus regarding the first embodiment of the invention;

FIG. 2 is an exemplary view depicting to explain an example of a plurality of voice media codecs supported by the VoIP terminals in the first embodiment of the invention;

FIG. 3 is an exemplary sequence view depicting transmission and reception operations of information among the VoIP terminals and the gateway apparatus in performing a peer-to-peer connection between two VoIP terminals in the first embodiment of the invention;

FIG. 4 is an exemplary sequence view depicting transmission and reception operations of information among the VoIP terminals and the gateway apparatus in performing a peer-to-peer connection between a plurality of VoIP terminals after performing the peer-to-peer connection show in FIG. 3;

FIG. 5 is an exemplary sequence view for explaining operations to make a conference connection among the plurality of VoIP terminals after performing the peer-to-peer connection shown in FIG. 4;

FIG. 6 is an exemplary sequence view depicting transmission and reception operations of information among the gateway apparatus and the plurality of VoIP terminals in performing a peer-to-peer connection conducted through renegotiation after drop-out of a VoIP terminal that is an organizer of the conference connection from the conference connection state shown in FIG. 5;

FIG. 7 is an exemplary schematic view depicting transmission and reception operations of information in renegotiating between a negotiation master and an incoming call side end point as the second embodiment of the invention;

FIG. 8 is an exemplary flowchart depicting a control procedure when a control unit renegotiates the conference connection in the second embodiment; and

FIG. 9 is an exemplary schematic view depicting an aspect of a voice connection when voice media codecs of the negotiation master and the incoming call side end point are not matched with each other in the second embodiment.

### DETAILED DESCRIPTION

Various embodiments according to the invention will be described hereinafter with reference to the accompanying drawings. In general, according to one embodiment of the invention, a gateway apparatus, which houses via a packet communication network a plurality of end points which support a plurality of codecs possible to be used for a communication, makes a communication connection through peer-to-peer between a first end point and a second end point using a shared codec on the packet communication network when receiving a communication connection request specifying the second end point from the first end point among the plurality of end points, and executes conference connection processing among the first, the second and a third end points via a processor executing conference synthesis processing when receiving a request for a conference connection specifying the third end point from the second end point in a communication state between the first and the second end points, comprising: a memory which stores information showing a plurality of codecs notified from an end point to be an originating call side in a communication connection through peer-to-peer among the first, the second and the third end points prior to the conference connection; a determiner which determines whether or not any codec matching between the first end point and the third end point exists based on information showing the plurality of codecs stored in the memory when receiving a request for dropping out from the conference connection from the second end point; and a controller which executes communication connection processing between the first end point and the third end point based on a determination result from the determiner.

### First Embodiment

According to an embodiment, FIG. 1 shows a block diagram illustrating a connection configuration among VoIP terminals and a gateway apparatus regarding the first embodiment of the invention. In FIG. 1, the symbol 1 indicates an IP network to transfer voice packets.

IP network 1 connects VoIP terminals EP1-EP3 as end points and the gateway apparatus 10.

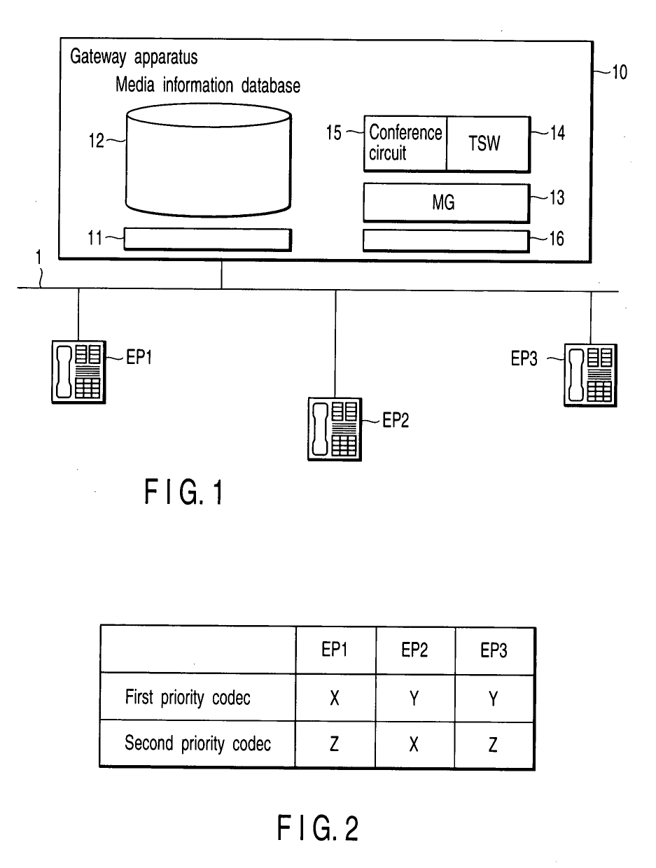

The VoIP terminals EP1-EP3 have speech processing functions and processing functions of media information including video, etc, and have voice media codecs depicted in FIG. 2, respectively.

The gateway apparatus 10 uses the voice media codecs to each VoIP terminal EP1-EP3, and instruct them to perform a peer-to-peer connection. The gateway apparatus 10 comprises of an IP network interface unit 11, a media information database 12, a media gateway resource 13 (MG), a time switch 14 (TSW), a conference circuit 15, and a control unit 16.

The IP network interface unit 11 houses the IP network 1. The IP network interface unit 11 conducts interface operations, such as transmission and reception processes, etc., to the VoIP terminals EP1-EP3 to be connected to the IP network 1. The IP network interface unit 11 communicates a variety of control information with respect to interface operations to the IP network 1 with the control unit 16.

The media information database 12 stores voice media codecs to be used among terminals connected through peer-to-peer in accordance with the instruction from the control unit 16.

The media gateway resource 13 performs signal conversions among the VoIP terminals EP1-EP3 and the non-VoIP terminals (not shown).

The time switch 14 carries out switching connections among the IP network 1 and a non-IP network (not shown), such as an analog telephone network, etc., in accordance with the instruction from the control unit 16.

The conference circuit 15 performs a conference connection among the VoIP terminals EP1-EP3 based on the instruction from the control unit 16.

The control unit 16 has a function of acquiring all voice media codecs owned by the VoIP terminals to be originating call sides connected through peer-to-peer and storing them in the media information database 12 in addition to a control function to achieve an operation as the gateway apparatus 10. The control unit 16 also has a function of notifying voice media codecs which are matched with one another to the remaining VoIP terminals EP1-EP3, when the VoIP terminal EP2 that is a conference organizer drops out from the conference connection.

Next to this, operations in the aforementioned configuration will be described.

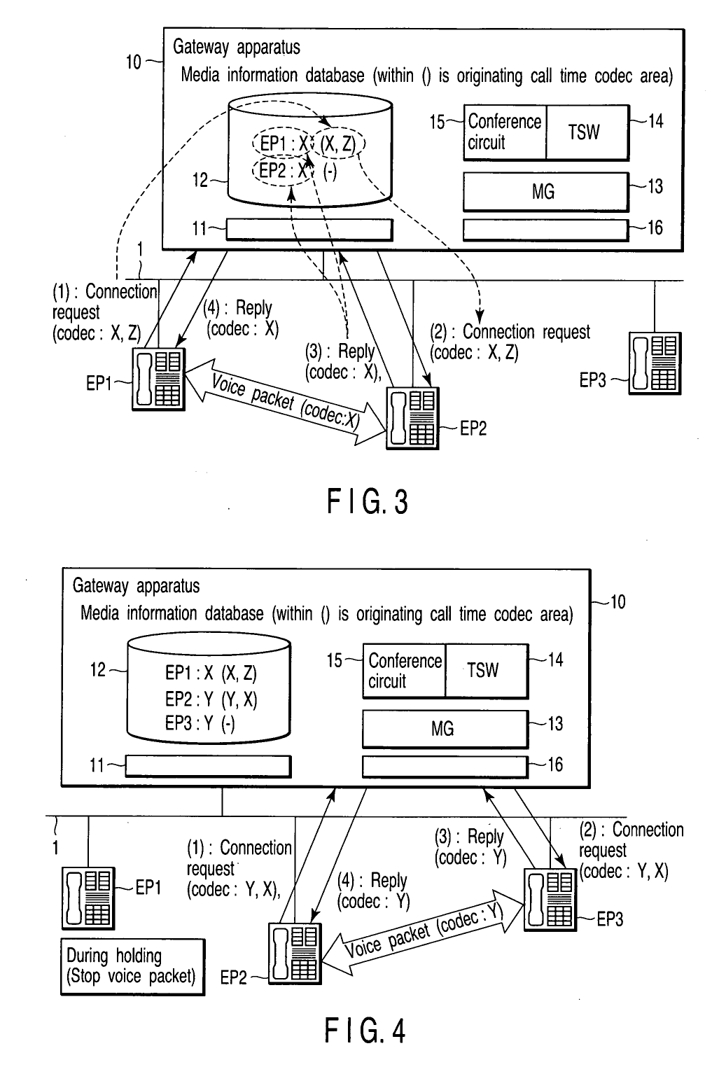

FIG. 3 is a sequence view illustrating transmission and reception operations among the VoIP terminals EP1, EP2 and the gateway apparatus 10 in performing the peer-to-peer connection between two VoIP terminals EP1 and EP2.

For instance, it is presumed that a user of the VoIP terminal EP1 carries out an operation to require a speech with a user of the VoIP terminal EP2. The VoIP terminal EP1 then transmits the connection request from the VoIP terminal EP1 to the gateway apparatus 10. At this time, the voice media codecs of the VoIP terminal EP1 being “X” and “Z”, they are set for the connection request.

The gateway apparatus 10, which has received the connection request, extracts the voice media codecs “X” and “Z” included in the connection request, and stores them in an originating call time codec area in the media information database 12.

Subsequently, the gateway apparatus 10 reads out a use codec of the VoIP terminal EP1 from the originating call time codec area in the media information database 12, and sets it to the connection request to the VoIP terminal EP2. The gateway apparatus 10 transmits the set connection request to the VoIP terminal EP2, and makes it perform incoming notification.

When the user conducts a reply operation in response to this incoming notification, the VoIP terminal EP2 returns the reply that it has accepted the connection by means of the voice media codec “X” to the gateway apparatus 10 because the VoIP terminal EP2 supports only the “X” among the received use codecs.

The gateway apparatus 10 which has received this reply stores the voice media codec “X” in the use codec area of the media information database while associating the voice media codec “X” with the information showing the VoIP terminal EP1 and with the information showing the VoIP terminal EP2, respectively. After this, the gateway apparatus 10 returns the reply that the connection using the voice media codec “X” has been accepted by the VoIP terminal EP2 to the VoIP terminal EP1.

Thus, the peer-to-peer connection using the voice media codec “X” is established between the VoIP terminal EP1 that is the originating call source and the VoIP terminal EP2 that is the incoming call destination.

FIG. 4 is a sequence view illustrating the transmission and reception operations of the information among the VoIP terminals EP2, EP3 and the gateway apparatus 10 in connecting the VoIP terminal EP2 and the VoIP terminal EP3 through peer-to-peer after the peer-to-peer connection shown in FIG. 3.

It is supposed that a speech has been made between the VoIP terminals EP1 and EP2. In this situation, it is assumed that the user performs an operation at the VoIP terminal EP2 to make the VoIP terminal EP3 participate in the conference connection. The VoIP terminal EP2 then transmits its connection request to the gateway apparatus 10. The connection request includes the voice media codecs “Y” and “X” to be supported by the VoIP terminal EP2.

When receiving the connection request, the gateway apparatus 10 withholds the connection between the VoIP terminal EP1 and the VoIP terminal EP2.

The voice media codec of the VoIP terminal EP2 being “Y” and “X”, the originating call time codec area in the media information database 12 stores the “Y” and “X”.

The gateway apparatus 10 reads out the use codecs “Y” and “X” from the originating call time codec area in the media information database 12, and sets them to the connection request for the VoIP terminal EP3. The gateway apparatus 10 then transmits the connection request to the VoIP terminal EP3, and makes it perform incoming call notification. When the user carries out a reply operation in response to the incoming call notification, the VoIP terminal EP3 returns a reply that the connection has been accepted by means of the voice media codec “Y” to the gateway apparatus 10 because the VoIP terminal EP3 supports only the codec “Y” among the use codecs.

The gateway apparatus 10 which has received this reply stores the voice media codec “Y” in the use code area in the media information database 12 while associating it with the information showing the VoIP terminal EP2 and the VoIP terminal EP3, respectively.

The gateway apparatus 10 returns a reply that the connection using the voice media codec “Y” has been accepted by the VoIP terminal EP3 to the VoIP terminal EP2.

Thus, a peer-to-peer connection in which the voice media codec “Y” is set as the use codec is established between the VoIP terminal EP2 that is the originating call source and the VoIP terminal EP3 that is the incoming call destination.

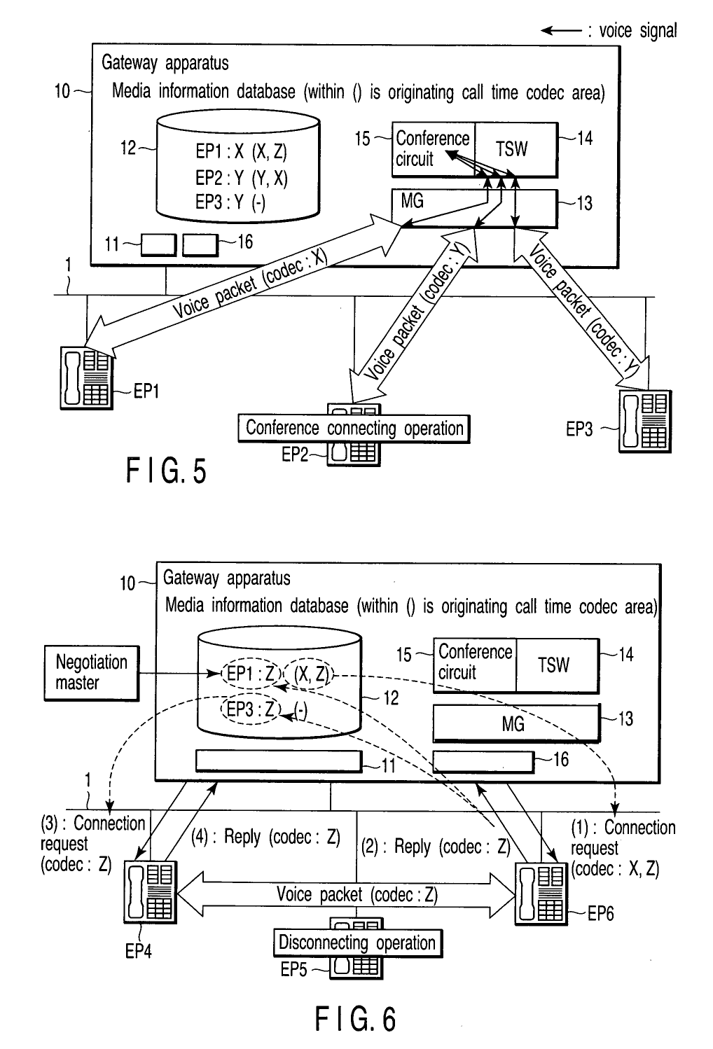

FIG. 5 is a sequence view for explaining operations to make a conference connection among the VoIP terminals EP1, EP2 and EP3 after the peer-to-peer connection shown in FIG. 4.

It is presumed that the user of the VoIP terminal EP2 has operated the conference connection. The transmission destinations of voice packets from the VoIP terminals EP1, EP2 and EP3 are then changed to the media gateway resource 13.

The media gateway resource 13 converts each voice packet to voice signals. The converted voice signals are synthesized at the conference circuit 15 through the time switch 14. The synthesized voice signals are converted into the voice packets again by the media gateway resource 13, and transmitted to each VoIP terminals EP1, EP2 and EP3.

At this time, the gateway apparatus 10 uses the voice media codec stored in the use codec area of the media information database 12 in order to connect among the media gateway resource 13 and each VoIP terminal EP1, EP2 and EP3. That is to say, the voice media codec “X” is used between the media gateway resource 13 and the VoIP terminal EP1, and the voice media codec “Y” is used between the media gateway resource 13 and the VoIP terminal EP2, and between the media gateway resource 13 and the VoIP terminal EP3.

FIG. 6 is a sequence view showing the transmission and reception operations of the information among the gateway apparatus 10, and the VoIP terminals EP1 and EP3 in the peer-to-peer connection performed through the renegotiation after the VoIP terminal EP2 that is the organizer of the conference connection has dropped out from the conference connection state shown in FIG. 5.

For example, when the VoIP terminal EP2 that is the organizer drops out, the gateway apparatus 10 performs the renegotiation, and try to perform the peer-to-peer connection between the remaining VoIP terminal EP1 and the VoIP terminal EP3.

The renegotiation notifies the voice media codec of one VoIP terminal (negotiation master), which stored in the originating call time codec area of the media information database 12, to the other VoIP terminal (incoming call side endpoint), and select the voice media codec possible to be accepted by the incoming call side end point when the conference connection state is changed into the peer-to-peer connection state.

Now, the voice media codec has not been stored in the originating call time codec area of the VoIP terminal EP3, so that the VoIP terminal EP1 is set as the negotiation master. The “X” and “Y” that are the voice media codecs of the VoIP terminal EP1, which is stored in the originating call time codec area, are set as the connection request for the VoIP terminal EP3 that is the incoming call side end point. The set connection request is transmitted to the VoIP terminal EP3 by the gateway apparatus 10. As the VoIP terminal EP3 which has received the connection request supports only “Z” among the received use codecs, the VoIP terminal EP3 returns the reply that the connection has been accepted by the voice media codec “Z” to the gateway apparatus 10. When receiving this reply, the gateway apparatus 10 stores the voice media codec “Z” in the use codec area of the media information database 12 while associating it with the information showing the VoIP terminal EP1 and with the information showing the VoIP terminal EP3, respectively. The gateway apparatus 10 returns the reply that the connection of the voice media codec “Z” has been accepted by the VoIP terminal EP3 to the VoIP terminal EP1.

Thus, even after the VoIP terminal EP2 that is the organizer dropped out from the conference connection, the peer-to-peer connection in which the voice media codec “Z” is set as the use codec is realized between the VoIP terminal EP1 that is the negotiation master and the VoIP terminal EP3 that is the incoming call side end point.

If the voice media codec of both VoIP terminals are stored in the originating call time codec area of the media information database 12 when the renegotiation is carried out, the gateway apparatus 10 sets any VoIP terminals as the negotiation master.

In such a first embodiment given above, the gateway apparatus 10 stores the information showing the voice media codec notified from the terminal to be the originating call side in the communication connection by peer-to-peer among the VoIP terminals EP1, EP2 and EP3 in the originating call time codec area of the media information database 12 before establishing the conference connection. After establishing the conference connection, when the VoIP terminal EP2 conducts the operation to drop out from the conference connection, the gateway apparatus 10 determines whether or not voice media codecs matching between the VoIP terminal EP1 and the VoIP terminal EP3 exist, that is, whether or not the VoIP terminal EP1 can be connected to the VoIP terminal EP3 by peer-to-peer based on the information showing the voice media codec stored in the originating call time codec area of the media information database 12. If the matched voice media codecs exist, the gateway apparatus 10 notifies the shared voice media codec to the VoIP terminal EP1 and the VoIP terminal EP3, and makes them perform the communication connection through peer-to-peer.

Accordingly, the gateway apparatus 10 determines the propriety of the peer-to-peer connection between the VoIP terminal EP1 and the VoIP terminal EP3 by using the voice media codec stored in the originating call time codec area in connecting through peer-to-peer, so that it is not needed to inquire a plurality of codecs supported respectively by the VoIP terminal EP1 and the VoIP terminal EP3 for each time, and can make the peer-to-peer connection between the VoIP terminal EP1 and the VoIP terminal EP3 with a simple procedure.

### Second Embodiment

The second embodiment of the present invention is one for explaining a coping method in the case in which the negotiation master and the incoming call side end point do not have the shared voice media codec.

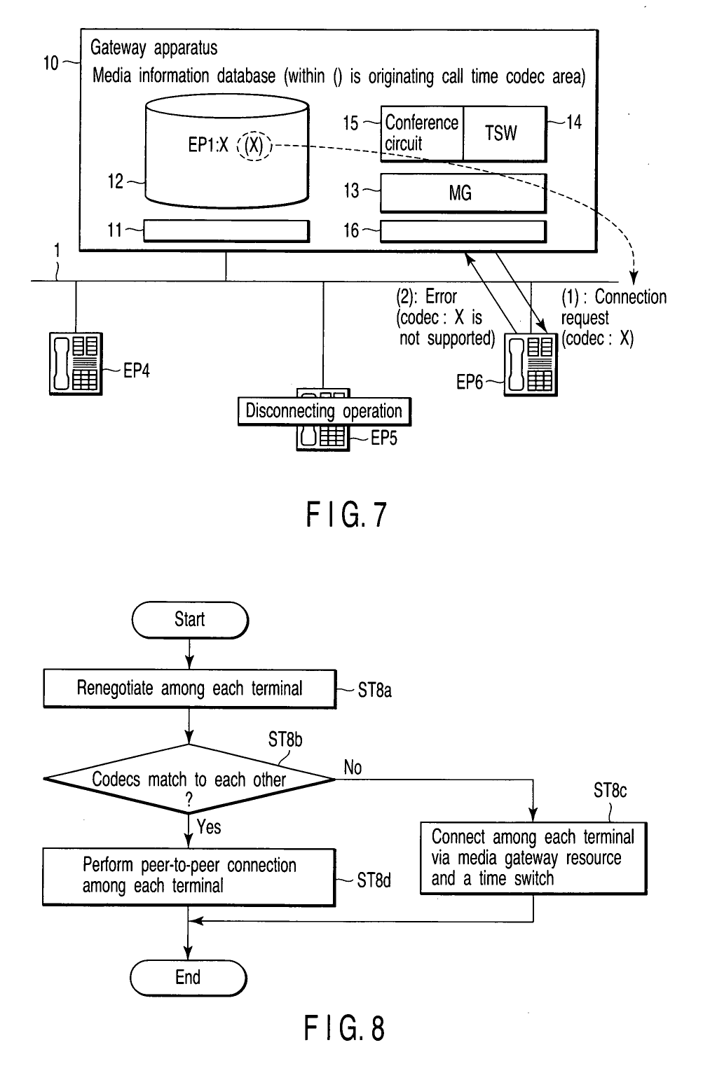

FIG. 7 is a schematic view depicting an example of the renegotiation, in the case in which the negotiation master and the incoming call side end point are different in voice media codec, as the second embodiment of the invention. At this time, for example, the VoIP terminal EP4 to be the negotiation master supports only the voice media codec “X”, and, for example, the VoIP terminal EP6 to be the incoming call side end point supports only the voice media codec “Y”. In FIG. 7, the same components as those of FIG. 1 are designated by the identical symbols and detailed descriptions thereof are omitted.

It is presumed that conference speeches have been made among the VoIP terminals EP4, EP5 and EP6. In this situation, it is supposed that the user to be the organizer conducts the operation to drop out from the conference by means of the VoIP terminal EP5. The control unit 16 of the gateway apparatus 10 then carries out the control processing shown in FIG. 8.

The control unit 16 firstly transmits the connection request including “X” that is the voice media codec of the VoIP terminal EP4, which is stored in the originating call time codec area of the media information database 12, to the VoIP terminal EP6 (block ST8a). As the VoIP terminal EP6 which has received the connection request does not support the received voice media codec “X”, it returns an error that the voice media code is not supported to the gateway apparatus 10. When receiving the error of non-support of the voice media codec, the control unit 16 determines that the incoming call side end point does not support the voice media codec of the negotiation, and shifts from a block ST8b to a block ST8c. Like the connection between the VoIP terminal and the non-VoIP terminal, the control unit 16 connects the VoIP terminal EP4 and the VoIP terminal EP6 through the media way resource 13 and the time switch 14.

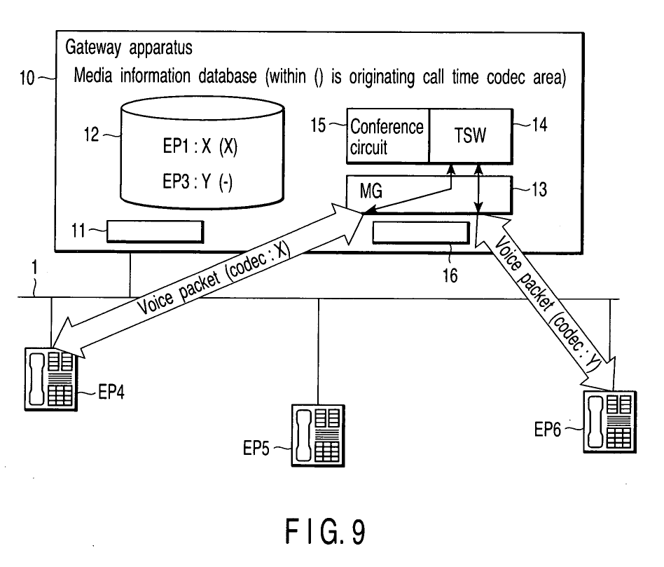

Thus, as shown in FIG. 9, even between the VoIP terminals EP4 and EP6 not having the shared voice media codec, the gateway apparatus 10 may maintain the voice connection after the organizer dropped out from the conference connection state.

As the determination result in the block ST8b, if the incoming call side end point supports the voice media codec of the negotiation master (Yes, in block ST8b), the control unit 16 connects the negotiation master and the incoming call side end point through peer-to-peer (block ST8d).

As mentioned above, in the second embodiment, in a case in which the shared codec between the VoIP terminal EP4 and the VoIP terminal EP6 does not exist, the gateway apparatus 10 also may prevent the speech from being brought into shutdown by connecting the VoIP terminal EP4 and the VoIP terminal EP6 through the media gateway resource 13 and the time switch 14. Thereby, the gateway apparatus 10 can continue the voice communication between the VoIP terminal EP4 and the VoIP terminal EP6.

### Other Embodiment

This embodiment is not limited to each given embodiment. For instance, each given embodiment having described about the example to one person drops out from a three-person conference connection, the same goes even in the case of a configuration of a four-person conference by making one person participate in the three-person conference connection. Further, the same goes even in the case to configure a further many-person conference.

Each of the forgoing embodiments having described about the example to carry out the conference connection among the VoIP terminals, the invention is not limited to the application to the VoIP terminals, among station lines, and the combination of the VoIP terminals and the station line may be an possible approach.

Each embodiment is applicable to a personal computer with a VoIP telephone application mounted thereon and electronic equipment to treat a voice signal, as a VoIP terminal other than the telephone set.

Other than this, this invention may be embodied in various forms, as for system configurations, types and functional configurations of the gateway apparatus, types and configurations of the VoIP terminals, the control procedure and its content in shifting to the peer-to-peer connection between two persons from the conference connection, and the like, may be made without departing from the spirit of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as world fall within the scope and spirit of the inventions.

What is claimed is:

1. A gateway apparatus, which houses via a packet communication network a plurality of end points, makes a communication connection through peer-to-peer between a first end point and a second end point using a shared codec on the packet communication network when receiving a communication connection request specifying the second end point from the first end point among the plurality of end points, and executes conference connection processing among the first, the second and a third end points via a processor when receiving a request for a conference connection specifying the third end point from the second end point in a communication state between the first and the second end points, the plurality of end points which support a plurality of codecs possible to be used for a communication, the processor executing conference synthesis processing, comprising:
a memory which stores information showing a plurality of codecs notified from an end point to be an originating call side in a communication connection through peer-to-peer among the first, the second and the third end points prior to the conference connection;
a determiner which determines whether or not any codec matching between the first end point and the third end point exists based on information showing the plurality of codecs stored in the memory, when receiving a request for dropping out from the conference connection from the second end point; and
a controller which executes communication connection processing between the first end point and the third end point based on a determination result from the determiner.

2. The gateway apparatus according to claim 1, wherein the controller makes a communication connection between the first and the third end points through peer-to-peer using a codec when it is determined that any codec matching to each other exists from a determination result by the determiner.

3. The gateway apparatus according to claim 1, wherein the controller connects the first and the third end points to the processor when it is determined that any codec matching to each other does not exist from a determination result by the determiner.

4. A renegotiation method to be used for a gateway apparatus which houses via a packet communication network a plurality of end points which support a plurality of codecs possible to be used for a communication, comprising:
making a communication connection through peer-to-peer between a first end point and a second end point using a shared codec on the packet communication network when receiving a communication connection request specifying the second end point from the first end point among the plurality of end points;
storing information showing a plurality of codecs notified from the first end point;
executing conference connection processing among the first, the second and a third end points via a processor executing conference synthesis processing when receiving a request for a conference connection specifying the third end point from the second end point in a communication state between the first and the second end points;
storing information showing a plurality of codecs notified from the second end point;
determining whether or not any codec matching between the first end point and the third end point exists based on information showing the plurality of codecs stored in the memory when receiving a request for dropping out from the conference connection from the second end point; and
executing communication connection processing between the first end point and the third end point based on a determination result.
